(19) United States
(12) Patent Application Publication
(10) Pub. No.: US 2024/0251322 A1
(43) Pub. Date: Jul. 25, 2024

(54) Satellite Communication Handover Method, Control Apparatus, and Terminal Device

(71) Applicant: BOE Technology Group Co., Ltd., Beijing (CN)

(72) Inventors: Li HAN, Beijing (CN); Wei LI, Beijing (CN); Feng QU, Beijing (CN); Biqi LI, Beijing (CN)

(21) Appl. No.: 17/917,946

(22) PCT Filed: Dec. 14, 2021
(86) PCT No.: PCT/CN2021/137744

§ 371 Date: Oct. 10, 2022

(51) Int. Cl. H04W 36/32; H04B 7/185; H04W 36/30

(52) U.S. Cl. CPC H04W 36/32; H04B 7/18541; H04W 36/30

(57) ABSTRACT

Disclosed is a satellite communication handover method, which includes: determining a scene where a user equipment is located according to a measurement report of the user equipment, determining a handover parameter corresponding to the scene, and sending a handover command is sent to the user equipment to instruct the user equipment to perform handover when the user equipment satisfies a first handover condition which is based on the handover parameter.

### TECHNICAL FIELD

The present disclosure relates to, but is not limited to, the field of communication technologies, in particular to a satellite communication handover method, a control apparatus, and a terminal device.

### BACKGROUND

As an important part of wireless communication, satellite communication has advantages of wide coverage, flexible network construction, a long propagation distance, and the like. Different from cell coverage of ground communication system, a satellite communication system has a large coverage range, which may cover remote areas and sea areas effectively, and solve a signal coverage problem of three major transportation systems of ground, sea, and air very well. Among them, a Low Earth Orbit (LEO) satellite communication system has advantages of small delay, seamless global coverage, and the like, and has gradually become a development trend of mobile wireless communication in the future.

### SUMMARY

The following is a summary of subject matters described herein in detail. The summary is not intended to limit the protection scope of claims.

Embodiments of the present disclosure provide a satellite communication handover method, a control apparatus, and a terminal device.

In one aspect, an embodiment of the present disclosure provides a satellite communication handover method, which includes: determining a scene where a user equipment is located according to a measurement report of the user equipment, determining a handover parameter corresponding to the scene, and sending a handover command to the user equipment to instruct the user equipment to perform handover when the user equipment satisfies a first handover condition which is based on the handover parameter.

In some exemplary implementation modes, the method of this embodiment further includes: determining a target beam of the user equipment according to a moving track of the user equipment.

In some exemplary implementation modes, the method of this embodiment further includes: monitoring whether the target beam is an edge beam of a serving satellite of the user equipment; when the target beam is the edge beam of the serving satellite of the user equipment, determining a target satellite according to the moving track of the user equipment, and sending a pre-handover request to the target satellite to facilitate the target satellite to reserve a resource.

In some exemplary implementation modes, before sending the handover command to the user equipment when the user equipment satisfies the first handover condition which is based on the handover parameter, the method further includes: sending a handover request to the target beam.

In some exemplary implementation modes, the measurement report at least includes: positioning information and velocity information for the user equipment. Determining the scene where the user equipment is located according to the measurement report of the user equipment includes: determining the scene where the user equipment is located according to the positioning information and the velocity information of the user equipment.

In some exemplary implementation modes, determining the handover parameter corresponding to the scene includes: determining the handover parameter corresponding to the scene according to a pre-stored mapping relationship between a scene and a handover parameter, wherein different scenes correspond to different handover parameters.

In some exemplary implementation modes, the user equipment satisfies the first handover condition which is based on the handover parameter, including: a difference between a reference signal receiving power from a target beam and a reference signal receiving power from a serving beam received by the user equipment is greater than or equal to the handover parameter.

In some exemplary implementation modes, the handover command carries the handover parameter.

In another aspect, an embodiment of the present disclosure provides a control apparatus including a memory and a processor. The memory is adapted to store a computer program, and the computer program is executed by the processor to implement acts of the satellite communication handover method as described above.

In another aspect, an embodiment of the present disclosure provides a satellite communication handover method, which includes: sending, by a user equipment, a measurement report to a serving satellite; and receiving, by the user equipment, a handover command sent by the serving satellite. The measurement report at least includes positioning information and velocity information of the user equipment. The handover command carries a handover parameter corresponding to a scene where the user equipment is located.

In some exemplary implementation modes, the satellite communication handover method of this embodiment further includes: sending, by the user equipment, a handover request to a target beam or a target satellite when the user equipment satisfies a second handover condition and a first handover condition that is based on the handover parameter.

In another aspect, an embodiment of the present disclosure provides a user equipment, which includes a memory and a processor. The memory is adapted to store a computer program, and the computer program is executed by the processor to implement acts of the satellite communication handover method as described above.

In another aspect, an embodiment of the present disclosure provides a non-transitory computer readable storage medium storing a computer program, and acts of the satellite communication handover method as described above are implemented when the computer program is executed.

Other aspects may be understood upon reading and understanding drawings and detailed description.

### BRIEF DESCRIPTION OF DRAWINGS

Accompanying drawings are used for providing further understanding of technical solutions of the present disclosure, constitute a part of the specification, and together with the embodiments of the present disclosure, are used for explaining the technical solutions of the present disclosure but not constituting limitations on the technical solutions of the present disclosure. Shapes and sizes of one or more components in the drawings do not reflect true scales, but are only intended to schematically describe contents of the present disclosure.

FIG. 1 is a schematic diagram of a satellite communication system according to at least one embodiment of the present disclosure.

FIG. 2 is a schematic flowchart of a satellite communication handover method according to at least one embodiment of the present disclosure.

FIG. 3 is an exemplary flowchart of a satellite communication handover method according to at least one embodiment of the present disclosure.

FIG. 4 is a schematic diagram of inter-beam handover according to at least one embodiment of the present disclosure.

FIG. 5 is a schematic diagram of inter-satellite handover according to at least one embodiment of the present disclosure.

FIG. 6 is another schematic flowchart of a satellite communication handover method according to at least one embodiment of the present disclosure.

FIG. 7 is a schematic diagram of a control apparatus according to at least one embodiment of the present disclosure.

FIG. 8 is a schematic diagram of a terminal device according to at least one embodiment of the present disclosure.

### DETAILED DESCRIPTION

Hereinafter embodiments of the present disclosure will be described in detail with reference to the accompanying drawings. Implementation modes may be implemented in multiple different forms. Those of ordinary skills in the art may easily understand such a fact that modes and contents may be transformed into one or more forms without departing from the purpose and scope of the present disclosure. Therefore, the present disclosure should not be explained as being limited to contents described in following implementation modes only. The embodiments in the present disclosure and features in the embodiments may be combined randomly with each other without conflict.

In the drawings, a size of one or more constituent elements, a thickness of a layer, or a region is sometimes exaggerated for clarity. Therefore, one mode of the present disclosure is not necessarily limited to the size, and shapes and sizes of multiple components in the accompanying drawings do not reflect actual scales. In addition, the drawings schematically illustrate ideal examples, and one mode of the present disclosure is not limited to shapes, numerical values, or the like shown in the drawings.

Ordinal numerals such as “first”, “second”, and “third” in the present disclosure are set to avoid confusion of constituents, but not intended for restriction in quantity. “Multiple” in the present disclosure means a quantity of two or more.

In the present disclosure, for convenience, wordings “central”, “up”, “down”, “front”, “back”, “vertical”, “horizontal”, “top”, “bottom”, “inside”, “outside”, etc., indicating orientations or positional relationships are used for describing positional relationships between composition elements with reference to the drawings. They are only for convenience of describing this specification and simplifying description, but do not indicate or imply that an involved apparatus or element must have a specific orientation and be structured and operated with the specific orientation, and thus should not be understood as limitations on the present disclosure. The positional relationships between the constituent elements may be changed as appropriate based on the directions according to which the constituent elements are described. Therefore, appropriate replacements may be made according to situations without being limited to the wordings described in the specification.

In the present disclosure, unless otherwise specified and defined, terms “mounting”, “mutual connection”, and “connection” should be understood in a broad sense. For example, a connection may be a fixed connection, or a detachable connection, or an integrated connection. It may be a mechanical connection or an electrical connection. It may be a direct mutual connection, or an indirect connection through middleware, or internal communication between two elements. Those of ordinary skills in the art may understand meanings of the above-mentioned terms in the present disclosure according to situations.

For a High Speed User Equipment (HSUE), since both a satellite (such as a Low Earth Orbit communication satellite) and the HSUE have high mobility, in order to ensure stable communication, frequent handover will be caused between satellites. In a high-speed mobile wireless communication environment, there are still many difficulties in providing high-quality, continuous, and reliable communication services. Therefore, in mobility management of a high-speed wireless communication system, handover is an essential and important link, which is very important in aspects such as ensuring uninterrupted communication during operation and improving quality of wireless communication.

An embodiment of the present disclosure provides a satellite communication handover method, which may improve a success rate of handover, thereby ensuring communication quality.

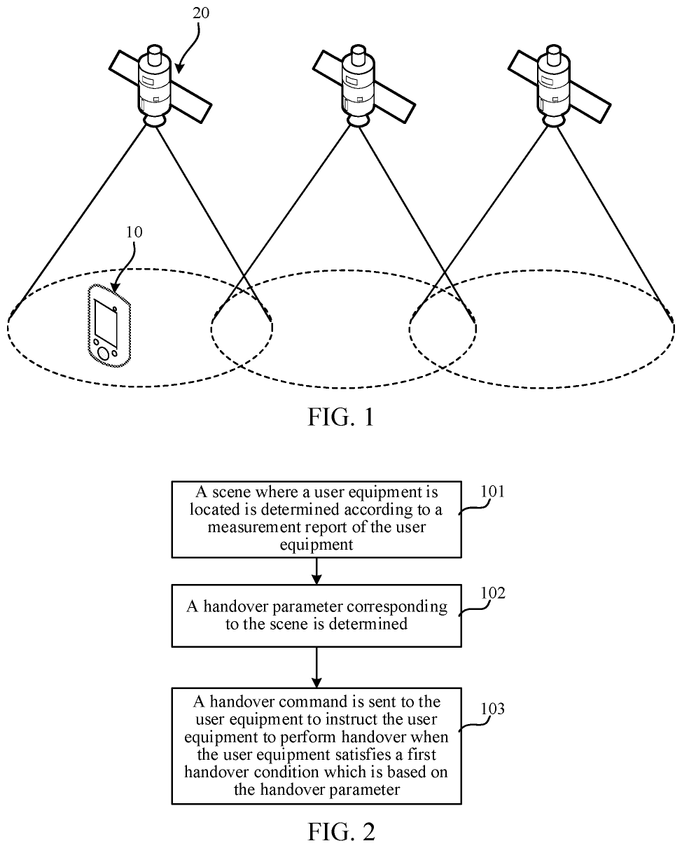

FIG. 1 is a schematic diagram of a satellite communication system according to at least one embodiment of the present disclosure. In some exemplary implementation modes, the satellite communication system may include a satellite constellation composed of LEO satellites 20 and a large number of User Equipment (UE) 10. Each LEO satellite 20 may include multiple beams, each of which constitutes a cell. Among them, a power value at a center of a beam is the largest, and a power value of the beam decreases toward an edge of the beam according to a certain law. When a high-speed mobile user equipment moves away from the center of the beam to an adjacent beam, a signal power and signal quality of a current serving beam gradually decrease while a signal power and signal quality of the adjacent beam gradually increase, when a certain degree is reached, handover between beams will be performed.

In the satellite communication system, handover may be divided into inter-beam handover and inter-satellite handover. Inter-beam handover means that a user equipment performs communication link handover between adjacent beams within a coverage range of a same satellite. Inter-satellite handover means that a user equipment performs communication link handover between adjacent satellites.

In some exemplary implementation modes, a high-speed vehicle (e.g., a high-speed train, an aircraft, and a ship) travels according to a fixed running route, and a motion of the high-speed vehicle is regular and predictable. Therefore, when the user equipment is located on the high-speed vehicle and follows movement of the high-speed vehicle, a moving track of the user equipment is also regular and predictable. Using regularity and predictability of the motion of the high-speed vehicle, prior information may be provided for a communication design, thereby greatly reducing a difficulty of the communication design.

FIG. 2 is a flowchart of a satellite communication handover method according to at least one embodiment of the present disclosure. In some exemplary implementation modes, the satellite communication handover method of this embodiment may be applied to an LEO satellite. However, this is not limited in the present embodiment.

As shown in FIG. 2, the satellite communication handover method of this embodiment may include following acts.

In act 101, a scene where a user equipment is located is determined according to a measurement report of the user equipment.

In act 102, a handover parameter corresponding to the scene is determined.

In act 103, a handover command is sent to the user equipment to instruct the user equipment to perform handover when the user equipment satisfies a first handover condition which is based on the handover parameter.

Taking a running environment of a high-speed train as an example, in an actual running environment of the high-speed train, the high-speed train will pass through various complex terrains and topographies such as a mountain, a tunnel, and a viaduct, and handover may occur in a transition region of any one or two of the above environments. An electromagnetic wave has different propagation characteristics in different environments, resulting in diverse characteristics of its wireless channel. Therefore, a handover mode in a specific environment may not be completely suitable for another environment, and a handover parameter suitable for a specific environment may not be completely suitable for another environment. In this exemplary implementation mode, the handover parameter corresponds to the scene and may be dynamically changed according to a change of the scene. Therefore, it is determined whether to perform handover according to the handover parameters corresponding to the scene where the user equipment is located, which may improve a success rate of handover.

In some exemplary implementation modes, a satellite with which the user equipment is currently connected may be referred to as a serving satellite and a satellite to be connected may be referred to as a target satellite. A beam with which the user equipment is currently connected may be referred to as a serving beam, and a beam to be connected may be referred to as a target beam.

In some exemplary implementation modes, the user equipment may report a measurement report to the serving satellite after receiving a measurement control signal from the serving satellite. Or, the user equipment may actively report a measurement report periodically. The serving satellite may determine the handover parameter and whether the user equipment needs to perform handover according to the measurement report reported by the user equipment. However, this is not limited in the present embodiment.

In some exemplary implementation modes, the method of this embodiment may further include: determining a target beam of the user equipment according to a moving track of the user equipment. In this example, the moving track of the user equipment is predictable and therefore the serving satellite may predetermine a target beam or target satellite of the user equipment. For example, the user equipment is located in a high-speed vehicle, and the moving track of the user equipment is consistent with a running route of the high-speed vehicle, which is regular and predictable. In this example, the serving satellite may predetermine the target beam or target satellite of the user equipment, and the target beam or target satellite may reserve a resource in advance, thereby reducing time needed for handover and achieving fast and seamless handover between a satellite and the high-speed mobile user equipment.

In some exemplary implementation modes, the method of this embodiment may further include: monitoring whether a target beam is an edge beam of the serving satellite of the user equipment; when the target beam is the edge beam of the serving satellite of the user equipment, determining a target satellite according to the moving track of the user equipment, and sending a pre-handover request to the target satellite to facilitate the target satellite to reserve a resource. In this example, before inter-satellite handover is performed, the serving satellite may send a pre-handover request to the target satellite so that the target satellite may perform admission control in advance, thereby reducing time needed for inter-satellite handover and achieving fast and seamless handover.

In some exemplary implementation modes, before the user equipment satisfies the first handover condition which is based on the handover parameter and sends the handover command to the user equipment, the method of this embodiment may further include: sending a handover request to the target beam so that the target beam reserves a resource.

In some exemplary implementation modes, the measurement report may at least include positioning information and velocity information of the user equipment. According to the positioning information and velocity information of the user equipment, the scene where the user equipment is located is determined. For example, the scene where the user equipment is located may be a scene where a high-speed train passes through a plain, or a scene where a ship sails, or a scene where a high-speed train enters a mountainous region from a plain. In this example, a position and characteristics of an environment where the user equipment is located may be determined according to the positioning information and the velocity information of the user equipment, thereby determining the scene where the user equipment is located. However, this is not limited in the present embodiment.

In some exemplary implementation modes, the handover parameter corresponding to the scene is determined according to a pre-stored mapping relationship between the scene and the handover parameter. Among them, different scenes correspond to different handover parameters. However, this is not limited in the present embodiment. For example, multiple similar scenes may correspond to a same handover parameter.

In some exemplary implementation modes, the user equipment satisfies the first handover condition which is based on the handover parameter, including: a difference between a Reference Signal Receiving Power (RSRP) from the target beam and an RSRP from the serving beam received by the user equipment is greater than or equal to the handover parameter. In this example, when the serving satellite determines that the user equipment satisfies the first handover condition, it is determined that the user equipment may perform handover. However, this is not limited in the present embodiment.

In some exemplary implementation modes, the handover command may carry the handover parameter. In this example, the serving satellite may send the handover parameter to the user equipment through the handover command so that the user equipment initiates handover autonomously when the first handover condition and a second handover condition are satisfied. For example, the second handover condition may include that the RSRP received by the user equipment from the serving beam is less than a first threshold. However, this is not limited in the present embodiment.

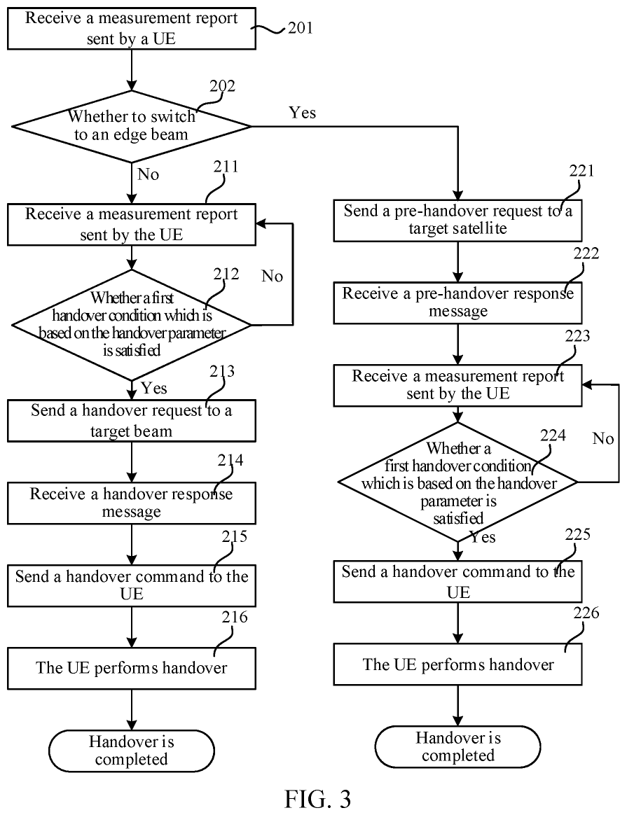

FIG. 3 is an exemplary flowchart of a satellite communication handover method according to at least one embodiment of the present disclosure. In some exemplary implementation modes, a satellite may periodically send a pilot signal. The pilot signal may include information (e.g. Identification (ID)) of the satellite and a beam. By receiving the pilot signal, a user equipment (UE) may acquire information of a satellite and a beam that are connectable at present, and determine an RSRP coming from a corresponding beam.

In some exemplary implementation modes, as shown in FIG. 3, the satellite communication handover method of this embodiment may include following acts.

In act 201, a serving satellite receives a measurement report sent by a user equipment (UE).

In some examples, the serving satellite may send a measurement control signal to the UE, and after receiving the measurement control signal, the UE reports the measurement report to the serving satellite. The measurement report may include the UE's current positioning information, velocity information, an ID of the serving beam and the received RSRP from the serving beam, and an ID of another connectable beam and the received RSRP from another connectable beam.

In act 202, the serving satellite monitors whether the user equipment is to switch to an edge beam.

In some examples, the serving satellite may determine a moving track of the UE according to the measurement report of the UE and predict a target beam according to the moving track. For example, a scene in which the UE is located may be determined according to the measurement report of the UE, thereby determining the moving track of the UE. For example, if the UE is currently in a scene of a high-speed train, the moving track of the UE may be determined according to a running track of the high-speed train, so that the target beam of the UE may be determined. After determining the target beam of the UE, the serving satellite may determine whether the target beam is an edge beam. When the target beam of the UE is the edge beam of the serving satellite, the serving satellite performs an inter-satellite handover process; the serving satellite performs an inter-beam handover process when the target beam of the UE is not the edge beam of the serving satellite.

In some exemplary implementation modes, the inter-beam handover process may include following acts.

In act 211, the serving satellite receives a measurement report sent by the UE.

In some examples, after receiving the measurement report of the UE, the serving satellite may determine a scene where the UE is located according to positioning information and velocity information in the measurement report. For example, the UE is in a scene where a high-speed train passes through a plain region, or the UE is in a scene where a high-speed train enters a mountainous region from a plain. Since the serving satellite pre-stores a mapping relationship between a scene and a handover parameter, a handover parameter corresponding to the scene where the UE is located may be determined according to the pre-stored mapping relationship. In some examples, the corresponding handover parameter may be set according to a channel condition of the scene. A handover parameter corresponding to an environment with a poor channel condition may be smaller than a handover parameter corresponding to an environment with a better channel condition. For example, in an environment with a poor channel such as a mountainous region and an urban region, a smaller handover parameter may be set to support fast handover; in an environment with a better channel such as an open ground and a viaduct, a slightly higher handover parameter may be set to ensure a success probability of handover. However, this is not limited in the present embodiment.

In act 212, the serving satellite determines whether the UE satisfies a first handover condition which is based on the handover parameter.

In some examples, the serving satellite may also determine whether the UE satisfies the first handover condition according to the measurement report of the UE. For example, the serving satellite determines whether a difference between an RSRP from a target beam and an RSRP from a serving beam received by the UE is greater than or equal to the handover parameter. When the serving satellite determines that the UE satisfies the first handover condition (e.g., the difference between the RSRP from the target beam and the RSRP from the serving beam received by the UE is greater than or equal to a handover parameter corresponding to a current scene), it is determined that the UE is to switch to the target beam, and an act 213 is performed. When the serving satellite determines that the UE does not satisfy the first handover condition (for example, the difference between the RSRP from the target beam and the RSRP from the serving beam received by the UE is smaller than the handover parameter corresponding to the current scene), it is determined that the UE does not need to switch to the target beam temporarily, and the act 211 is performed. The serving satellite continues receiving the measurement report reported by the UE, and updates the handover parameter according to a scene determined according to the measurement report, and re-determines whether the UE satisfies the first handover condition.

In act 213, the serving satellite sends a handover request to a target beam.

In act 214, the serving satellite receives a handover response message returned by the target beam.

In some examples, the serving satellite may send the handover request to the target beam, and the target beam may evaluate its receiving capability after receiving the handover request. When the target beam decides to accept the handover request, it returns the handover response message and reserves a resource for the UE.

In act 215, the serving satellite sends a handover command to the UE.

In act 216, the UE performs handover.

In some examples, the serving satellite may send the handover command to the UE after receiving the handover response message, and the UE begins to perform handover after receiving the handover command. For example, according to information contained in the handover command, the UE adjusts a frequency and establishes a communication link with the target beam.

In some examples, the handover command sent by the serving satellite may carry a handover parameter so that the UE autonomously performs handover in a case that the first handover condition and a second handover condition are satisfied. For example, the second handover condition includes that an RSRP received by the UE from a serving beam is less than a first threshold. When signal quality of the serving beam received by the UE is changed abruptly, the UE may autonomously determine whether to perform handover according to the handover parameter, and autonomously perform handover when the first handover condition is met, thus ensuring communication.

In some exemplary implementation modes, when the serving satellite monitors that a current target beam of the UE is an edge beam of the serving satellite, the serving satellite may perform an inter-beam handover process so that the UE switches to the edge beam while the serving satellite may prepare for subsequent inter-satellite handover of the UE.

In some exemplary implementation modes, the inter-satellite handover may include following acts.

In act 221, the serving satellite sends a pre-handover request to a target satellite.

In some examples, when the serving satellite monitors that a current target beam of the UE is an edge beam of the serving satellite, the serving satellite may select a most likely target satellite from a list of target satellites close to the UE according to a moving track of the UE and send the pre-handover request to the target satellite. Since a running track of the UE following a high-speed train is fixed and known, and a running track of a satellite is also fixed, a suitable target satellite may be determined by using the known running track of the UE and the running track of the satellite.

In some examples, the pre-handover request may contain related information of the UE, such as an ID, velocity information, a Quality of Service (QOS) parameter of a carried service, and the like of the UE.

In act 222, the serving satellite receives a pre-handover response message returned by the target satellite.

In some examples, after receiving the pre-handover request, the target satellite may use an admission control algorithm to determine whether it may provide a service to the UE that is about to enter its coverage range, that is, evaluating its ability of accepting the request. When the target satellite decides to accept the pre-handover request, the pre-handover response message is returned to the serving satellite. The admission control algorithm of the target satellite is not limited in this embodiment.

In act 223, the serving satellite receives a measurement report sent by the UE.

In some examples, after receiving the measurement report of the UE, the serving satellite may determine a scene where the UE is located according to positioning information and velocity information of the measurement report. For example, the UE is in a scene where a high-speed train passes through a plain region, or the UE is in a scene where a high-speed train enters a mountainous region from a plain. The serving satellite pre-stores a mapping relationship between a scene and a handover parameter, and a handover parameter corresponding to the scene where the UE is located may be determined according to the pre-stored mapping relationship. For example, the corresponding handover parameter may be set according to a channel condition of the scene. For example, in an environment with a poor channel condition such as a mountainous region and an urban region, a smaller handover parameter may be set to support fast handover; in an environment with a better channel condition such as an open ground and a viaduct, a slightly higher handover parameter may be set to ensure a success probability of handover. However, this is not limited in the present embodiment.

In act 224, the serving satellite determines whether the UE satisfies a first handover condition which is based on the handover parameter.

In some examples, the serving satellite may determine whether the UE satisfies the first handover condition according to the measurement report of the UE, for example, determine whether a difference between an RSRP from a target beam and an RSRP from a serving beam received by the UE is greater than or equal to the handover parameter. When the serving satellite determines that the UE satisfies the first handover condition, it is determined that the UE needs to perform handover and switches to the target satellite, that is, an act 225 is performed. When the serving satellite determines that the UE does not satisfy the first handover condition, it is determined that the UE does not need to switch to the target satellite temporarily, that is, the act 223 is performed. The serving satellite updates the handover parameter according to the measurement report of the UE and re-determines whether the UE meets the first handover condition.

In act 225, the serving satellite sends a handover command to the UE.

In act 226, the UE performs handover.

In some examples, the serving satellite may send the handover command to the UE after determining that the UE satisfies the first handover condition, and the UE begins performing handover after receiving the handover command. For example, according to information contained in the handover command, the UE adjusts a frequency and establishes a communication link with the target satellite.

In some examples, the handover command sent by the serving satellite may carry a handover parameter so that the UE autonomously performs handover in a case that the first handover condition and a second handover condition are satisfied. However, this is not limited in the present embodiment.

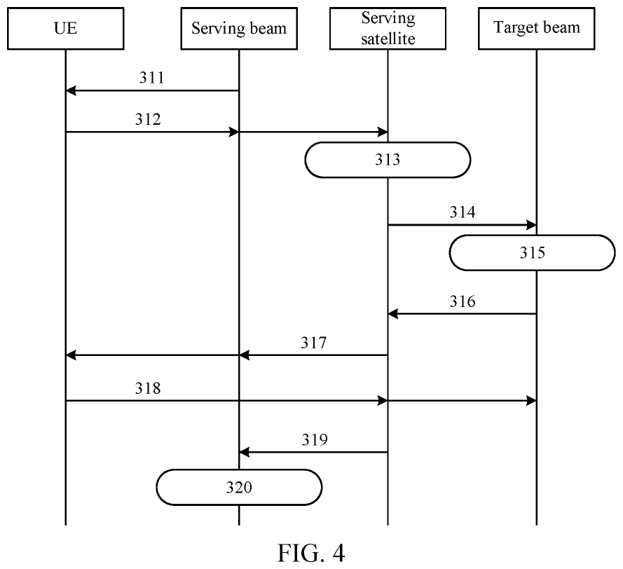

FIG. 4 is a schematic diagram of inter-beam handover according to at least one embodiment of the present disclosure. In some exemplary implementation modes, as shown in FIG. 4, a process of inter-beam handover may include following acts.

In act 311, a serving beam sends a measurement control signal to a User Equipment (UE).

In act 312, the UE reports a measurement report to the serving beam, and the serving beam reports the measurement report of the UE to a serving satellite.

In act 313, the serving satellite determines that the UE switches to a target beam.

In this act, a scene wherein the UE is located and a moving track of the UE may be determined according to the measurement report of the UE. The target beam is determined according to the moving track of the UE. According to the scene in which the UE is located, a corresponding handover parameter is determined, and whether the UE satisfies a first handover condition which is based on the handover parameter is determined. The serving satellite determines that the UE satisfies the first handover condition which is based on the handover parameter, then it is determined that the UE needs to switch to the target beam. In this example, the target beam is not an edge beam of the serving satellite.

In act 314, the serving satellite sends a handover request to the target beam.

In act 315, the target beam determines whether to accept the handover request according to an admission control algorithm. The admission control algorithm of the target beam is not limited in this embodiment.

In act 316, the target beam returns a handover response message. In this example, the target beam accepts the handover request, reserves a resource for the UE, and returns the handover response message to the serving satellite.

In act 317, the serving satellite sends a handover command to the serving beam, and the serving beam sends the handover command to the UE.

In act 318, the UE sends a handover command response message to the serving satellite, and the serving satellite sends the handover command response message to the target beam. In this act, the UE starts to perform handover after receiving the handover command, adjusts a frequency according to information contained in the handover command, and establishes a communication link with the target beam.

In act 319, the serving satellite notifies the serving beam to release a user context.

In act 320, the serving beam releases the resource.

In this example, after the UE establishes the communication link with the target beam, an original serving beam may release a channel resource between it and the UE. In this way, the inter-beam handover is completed.

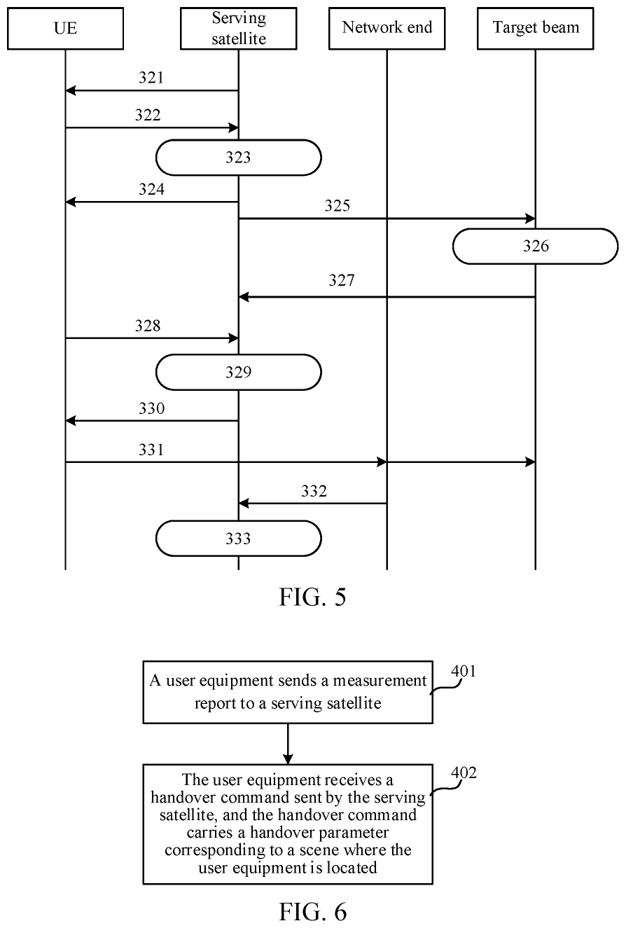

FIG. 5 is a schematic diagram of inter-satellite handover according to at least one embodiment of the present disclosure. In some exemplary implementation modes, as shown in FIG. 5, a process of inter-satellite handover may include following acts.

In act 321, a serving satellite sends a measurement control signal to a User Equipment (UE).

In act 322, the UE reports a measurement report to the serving satellite.

In act 323, the serving satellite determines that the UE switches to a target beam and that the target beam is an edge beam.

In this act, a scene wherein the UE is located and a moving track of the UE may be determined according to the measurement report of the UE. The target beam is determined according to the moving track of the UE. According to the scene in which the UE is located, a corresponding handover parameter is determined, and whether the UE satisfies a first handover condition which is based on the handover parameter is determined. The serving satellite determines that the UE satisfies the first handover condition which is based on the handover parameter, then it is determined that the UE needs to switch to the target beam. In this example, the target beam is an edge beam of the serving satellite.

In act 324, the serving satellite sends a handover command to the UE.

In this act, the UE may establish a communication link with the target beam according to the handover command.

In act 325, the serving satellite sends a pre-handover request to a target satellite.

In this act, the serving satellite monitors that the UE has switched to the edge beam, then determines a target satellite in advance according to the moving track of the UE, and sends a pre-handover request to the target satellite.

In act 326, the target satellite determines whether to accept the pre-handover request according to an admission control algorithm.

In this act, after receiving the pre-handover request, the target satellite evaluates an ability of accepting the request according to the admission control algorithm to determine whether to accept the pre-handover request. The admission control algorithm of the target satellite is not limited in this embodiment.

In act 327, the target satellite sends a response message for the pre-handover request to the serving satellite.

In this act, the target satellite determines to accept the pre-handover request and returns the response message for the pre-handover request to the serving satellite.

In act 328, the serving satellite receives the measurement report reported by the UE.

In act 329, the serving satellite determines that the UE switches to the target satellite.

In this act, the serving satellite may determine a scene wherein the UE is located and a moving track of the UE according to the measurement report of the UE. The target satellite is determined according to the moving track of the UE. According to the scene in which the UE is located, a corresponding handover parameter is determined, and whether the UE satisfies a first handover condition which is based on the handover parameter is determined. The serving satellite determines that the UE satisfies the first handover condition which is based on the handover parameter, then it is determined that the UE needs to switch to the target satellite.

In act 330, the serving satellite sends a handover command to the UE.

In act 331, the UE sends a response message for the handover command to the target satellite through a network end. In this act, the UE starts to perform handover after receiving the handover command, adjusts a frequency according to information contained in the handover command, and establishes a communication link with the target satellite.

In act 332, the network end notifies the serving satellite to release a user context.

In act 333, the serving satellite releases a resource.

In this example, after the UE establishes the communication link with the target satellite, an original serving satellite may release a channel resource between it and the UE. In this way, the inter-satellite handover is completed.

According to the satellite communication handover method provided by this exemplary implementation mode, whether the UE satisfies the first handover condition is determined based on the handover parameter corresponding to the scene in which the UE is located. For example, when the UE is in different scenes, it may be determined whether the UE performs handover based on different handover parameters. In this way, a success rate of handover may be improved. Moreover, the target beam or target satellite of the UE may be determined in advance according to the moving track of the UE, so that the target beam or target satellite may perform admission control in advance. A pre-handover mechanism of this embodiment may reduce handover time, thereby achieving fast and seamless handover.

In other exemplary implementation modes, the scene in which the UE is located may be a sailing scene of a ship and a handover parameter corresponding to the scene may remain determined. A moving track of the UE is determined according to a sailing route of the ship, and a target beam or target satellite is determined according to the moving track of the UE.

Other implementation modes of this embodiment may refer to descriptions of the aforementioned embodiments and will not be repeated here.

In other exemplary implementation modes, the scene where the UE is located may be a navigation scene of an aircraft, and a handover parameter may be dynamically adjusted according to a change of a specific environment of the navigation scene of the aircraft. A moving track of the UE may be determined according to a flight route of the aircraft. In some examples, the target beam or target satellite may be dynamically predicted according to information such as velocity information and a moving direction of the UE and an angle of a satellite. Other implementation modes of this embodiment may refer to descriptions of the aforementioned embodiments and will not be repeated here.

FIG. 6 is another flowchart of a satellite communication handover method according to at least one embodiment of the present disclosure. In some exemplary implementation modes, as shown in FIG. 6, the satellite communication handover method of this embodiment may be applied to a user equipment and includes following acts.

In act 401, a user equipment sends a measurement report to a serving satellite. The measurement report at least includes positioning information and velocity information of the user equipment.

In act 402, the user equipment receives a handover command sent by the serving satellite, and the handover command carries a handover parameter corresponding to a scene where the user equipment is located.

In some exemplary implementation modes, the method of this embodiment may further include: the user equipment sends a handover request to a target beam or a target satellite when the user equipment satisfies a second handover condition and a first handover condition that is based on the handover parameter.

A detailed implementation mode of this embodiment may refer to descriptions of the aforementioned embodiments and will not be repeated here.

An embodiment of the present disclosure also provides a control apparatus, including a memory and a processor, wherein the memory is adapted to store a computer program, and the computer program is executed by the processor to implement acts of the satellite communication handover method at the satellite side as described above.

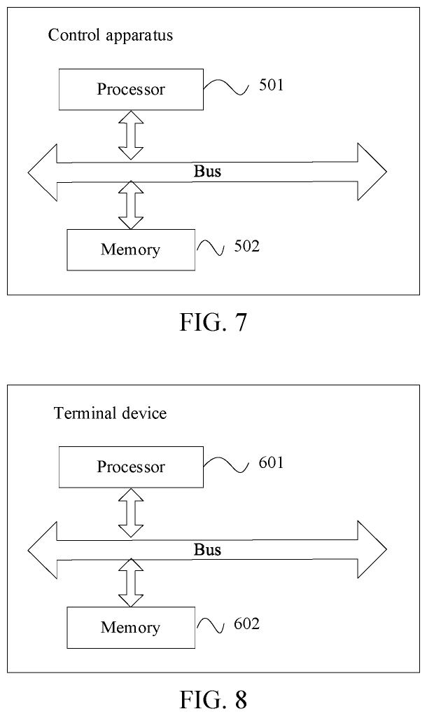

FIG. 7 is a schematic diagram of a control apparatus according to at least one embodiment of the present disclosure. In some exemplary implementation modes, as shown in FIG. 7, the control apparatus of this embodiment includes a processor 501 and a memory 502. The processor 501 and the memory 502 may be connected through a bus. The memory 502 is adapted to store a computer program, and when the computer program is executed by the processor 501, acts of the satellite communication handover method according to the above embodiments are implemented.

In some exemplary implementation modes, the processor 501 may include a processing apparatus such as a Micro Control Unit (MCU) or a Field Programmable Gate Array (FPGA). The memory 502 may store a software program and modules, of application software, such as program instructions or modules corresponding to an interaction method in this embodiment. The processor 501 performs various function applications and data processing by running the software program and modules stored in the memory 502, for example, implements the method provided in this embodiment. The memory 502 may include a high-speed random access memory, and may also include a non-volatile memory such as one or more magnetic storage apparatuses, flash memories, or other non-volatile solid-state memories. In some examples, the memory 502 may include memories remotely provided with respect to the processor 501, and these remote memories may be connected to an electronic device through a network. Examples of the above network include, but are not limited to, the Internet, an intranet, a local area network, a mobile communication network, and combinations thereof.

An embodiment of the present disclosure also provides a terminal device, including: a memory and a processor, wherein the memory is adapted to store a computer program, and the computer program is executed by the processor to implement acts of the satellite communication handover method at the user equipment side as described above.

FIG. 8 is a schematic diagram of a terminal device according to at least one embodiment of the present disclosure. In some exemplary implementation modes, as shown in FIG. 8, the control apparatus of this embodiment includes a processor 601 and a memory 602. The processor 601 and the memory 602 may be connected through a bus. The memory 602 is adapted to store a computer program, and when the computer program is executed by the processor 601, acts of the satellite communication handover method according to the above embodiments are implemented.

In some exemplary implementation modes, the processor 601 may include a processing apparatus such as an MCU or an FPGA. The memory 602 may store a software program and modules, of application software, such as program instructions or modules corresponding to an interaction method in this embodiment. The processor 601 performs various function applications and data processing by running the software program and modules stored in the memory 602, for example, implements the method provided in this embodiment. The memory 602 may include a high-speed random access memory, and may also include a non-volatile memory such as one or more magnetic storage apparatuses, flash memories, or other non-volatile solid-state memories. In some examples, the memory 602 may include memories remotely provided with respect to the processor 601, and these remote memories may be connected to an electronic device through a network. Examples of the above network include, but are not limited to, the Internet, an intranet, a local area network, a mobile communication network, and combinations thereof.

In addition, at least one embodiment of the present disclosure also provides a non-transitory computer-readable storage medium storing a computer program, wherein acts of the above-mentioned satellite communication handover method are implemented when the computer program is executed.

Those of ordinary skills in the art may understand that all or some of acts in methods, functional modules or units in systems and apparatuses disclosed above may be implemented as software, firmware, hardware, and an appropriate combination thereof. In a hardware implementation mode, a division between functional modules or units mentioned in the above description does not necessarily correspond to a division of physical components. For example, a physical component may have multiple functions, or a function or an act may be performed by several physical components in cooperation. Some certain components or all components may be implemented as software executed by a processor such as a digital signal processor or a microprocessor, or implemented as hardware, or implemented as an integrated circuit such as an application specific integrated circuit. Such software may be distributed in a computer-readable medium, and the computer-readable medium may include a computer storage medium (or a non-transitory medium) and a communication medium (or a transitory medium). As known to those of ordinary skill in the art, the term computer storage medium includes volatile and nonvolatile, and removable and irremovable media implemented in any method or technology for storing information (for example, a computer-readable instruction, a data structure, a program module, or other data). The computer storage medium includes, but is not limited to, RAM, ROM, EEPROM, a flash memory or another memory technology, CD-ROM, a digital versatile disk (DVD) or another optical disk storage, a magnetic cassette, a magnetic tape, a magnetic disk storage, or another magnetic storage apparatus, or any other medium that may be configured to store desired information and may be accessed by a computer. In addition, it is known to those of ordinary skill in the art that the communication medium usually includes a computer-readable instruction, a data structure, a program module, or other data in a modulated data signal of, such as, a carrier or another transmission mechanism, and may include any information delivery medium.

The above shows and describes basic principles, main features, and advantages of the present disclosure. The present disclosure is not limited by the above embodiments. The above embodiments and descriptions in the specification only illustrate the principles of the present disclosure. Without departing from the spirit and scope of the present disclosure, there will be many changes and improvements in the present disclosure, and all of these changes and improvements fall within the protection scope of the present disclosure.

1. A satellite communication handover method, comprising:
determining a scene where a user equipment is located according to a measurement report of the user equipment;
determining a handover parameter corresponding to the scene; and
sending a handover command to the user equipment to instruct the user equipment to perform handover when the user equipment satisfies a first handover condition which is based on the handover parameter.

2. The method according to claim 1, further comprising: determining a target beam of the user equipment according to a moving track of the user equipment.

3. The method according to claim 2, further comprising: monitoring whether the target beam is an edge beam of a serving satellite of the user equipment; and
determining a target satellite according to the moving track of the user equipment when the target beam is the edge beam of the serving satellite of the user equipment, and sending a pre-handover request to the target satellite for the target satellite to reserve a resource.

4. The method according to claim 2, wherein before sending the handover command to the user equipment when the user equipment satisfies the first handover condition which is based on the handover parameter, the method further comprises: sending a handover request to the target beam.

5. The method according to claim 1, wherein the measurement report at least comprises: positioning information and velocity information of the user equipment;
determining the scene where the user equipment is located according to the measurement report of the user equipment comprises: determining the scene where the user equipment is located according to the positioning information and the velocity information of the user equipment.

6. The method according to claim 1, wherein determining the handover parameter corresponding to the scene comprises: determining the handover parameter corresponding to the scene according to a pre-stored mapping relationship between a scene and a handover parameter, wherein different scenes correspond to different handover parameters.

7. The method according to claim 1, wherein the user equipment satisfies the first handover condition which is based on the handover parameter, comprising: a difference between a reference signal receiving power from a target beam and a reference signal receiving power from a serving beam received by the user equipment is greater than or equal to the handover parameter.

8. The method according to claim 1, wherein the handover command carries the handover parameter.

9. A control apparatus, comprising a processor and a memory, wherein the memory is adapted to store a computer program, and the computer program is executed by the processor to implement acts of the satellite communication handover method according to claim 1.

10. A satellite communication handover method, comprising:
sending, by a user equipment, a measurement report to a serving satellite, wherein the measurement report at least comprises: positioning information and velocity information of the user equipment; and
receiving, by the user equipment, a handover command sent by the serving satellite, wherein the handover command carries a handover parameter corresponding to a scene where the user equipment is located.

11. The method according to claim 10, further comprising: sending, by the user equipment, a handover request to a target beam or target satellite when the user equipment satisfies a second handover condition and a first handover condition which is based on the handover parameter.

12. A terminal device, comprising a processor and a memory, wherein the memory is adapted to store a computer program, and the computer program is executed by the processor to implement acts of the satellite communication handover method according to claim 10.

13. A non-transitory computer-readable storage medium, storing a computer program, wherein when the computer program is executed, acts of the satellite communication handover method according to claim 1 are implemented.

14. The method according to claim 3, wherein before sending the handover command to the user equipment when the user equipment satisfies the first handover condition which is based on the handover parameter, the method further comprises: sending a handover request to the target beam.

15. The method according to claim 2, wherein the measurement report at least comprises: positioning information and velocity information of the user equipment;
determining the scene where the user equipment is located according to the measurement report of the user equipment comprises: determining the scene where the user equipment is located according to the positioning information and the velocity information of the user equipment.

16. The method according to claim 3, wherein the measurement report at least comprises: positioning information and velocity information of the user equipment;
determining the scene where the user equipment is located according to the measurement report of the user equipment comprises: determining the scene where the user equipment is located according to the positioning information and the velocity information of the user equipment.

17. The method according to claim 4, wherein the measurement report at least comprises: positioning information and velocity information of the user equipment;
determining the scene where the user equipment is located according to the measurement report of the user equipment comprises: determining the scene where the user equipment is located according to the positioning information and the velocity information of the user equipment.

18. The method according to claim 2, wherein determining the handover parameter corresponding to the scene comprises: determining the handover parameter corresponding to the scene according to a pre-stored mapping relationship between a scene and a handover parameter, wherein different scenes correspond to different handover parameters.

19. The method according to claim 3, wherein determining the handover parameter corresponding to the scene comprises: determining the handover parameter corresponding to the scene according to a pre-stored mapping relationship between a scene and a handover parameter, wherein different scenes correspond to different handover parameters.

20. The method according to claim 4, wherein determining the handover parameter corresponding to the scene comprises: determining the handover parameter corresponding to the scene according to a pre-stored mapping relationship between a scene and a handover parameter, wherein different scenes correspond to different handover parameters.
